(19) United States
(12) Patent Application Publication
(10) Pub. No.: US 2008/0307680 A1
(43) Pub. Date: Dec. 18, 2008

(54) Snow Block Forming & Transportation Device & Method of Use Thereof

(76) Inventor: Michael Charles Schlichting, Cranford, NJ (US)

Correspondence Address: Michael Charles Schlichting, 1014 Orange Ave, Cranford, NJ, 07016, US

(21) Appl. No.: 12/138,410

(22) Filed: Jun. 12, 2008

Related U.S. Application Data
(60) Provisional application No. 60/943,334, filed on Jun. 12, 2007.

(51) Int. Cl. B30B 9/28

(52) U.S. Cl. 37/225

(57) ABSTRACT

A new snow block forming & transportation device & method of use thereof which generally comprises a main block form housing body, a main housing body integrated handle, an internal cap spring, a spring well, a snow release push button cap, a snow release plunger shaft, a plunger and plunger plate, and a snow shaping trowel, and which allows a user to easily and quickly create, transport, and position, uniformly shaped block of snow for the use of creating snow structures.

This application claims the prior filing benefit of provisional patent application No. 60943334 filed on Jun. 12 2007.

### BACKGROUND OF THE INVENTION

### Field of the Invention

This invention relates generally to the field of snow molding devices. Moreover it pertains specifically to a snow block forming & transportation device that will allow a user to pack and shape material, such as snow, into rectangular shaped blocks, and then eject or release the packed material.

### SUMMARY OF THE INVENTION

In view of the limitations now present in the prior art, the present invention provides a new and useful Snow Block Forming & Transportation Device & Method of Use Thereof, which is simpler in construction, more universally functional and more consistent in operation than known prior art snow block making devices.

The purpose of the present invention is to provide a new Snow Block Forming & Transportation Device & Method of Use Thereof that will allow a user to pack and shape material, such as snow, into rectangular shaped blocks, and then eject or release the packed material for the use of constructing or building snow structures. It is also a purpose of the present invention to provide a new Snow Block Forming & Transportation Device & Method of Use Thereof that has many novel features not offered by the prior art apparatus that result in a new Snow Block Forming & Transportation Device & Method of Use Thereof which is not apparent, obvious, or suggested, either directly or indirectly by any of the prior art apparatus.

The present invention(110) in the preferred embodiment generally comprises a main block form housing body(111), a main housing body integrated handle(112), an internal cap spring, a spring well(113), a snow release push button cap(114), a snow release plunger shaft(115), a plunger and plunger plate(116), and a snow shaping trowel(117), with the main block form housing body(111) having a rectangular shape with substantially planar, horizontal top surface, substantially planar, vertical first and second side surfaces, and vertical first and second end surfaces, with each side and end piece being fixably attached at the distal edges to the adjacent perpendicular planar piece, and at the top edge to the top horizontal planar piece, the assemblage resulting in a rectangular shaped block having an opening(118) at the bottom, and planar vertical interior side(119) and end walls(120) with a planar horizontal interior top surface(121). Further, the top surface side walls, end walls, handle and handle shaft are of a single molded or cast embodiment(121), with the handle(112) forming a generally “ [symbol] ” shape with the first and second legs attaching to the top surface(122) of the main block form housing body(111), and further comprising an array of structural rib fins(123) disposed a distance from each other along the length of the handle(112).

A main snow release plunger shaft(115) is integrated with the handle(112) and the main block form housing body(111) as a single cast or molded embodiment(121) and spans between and is connected to the “ [symbol] ” shaped handle and the top surface(122) of the main block form housing body(111) so as to extend upward from the exterior top surface(122) of the main block form housing body(111) in a perpendicular manner, with the plunger shaft(115) further having a cylindrical shaped opening at both ends with a hollow core that aligns with a circular opening(130) in the main block form top surface(122). The snow release push button(114) is inserted into a cylindrical opening in the top center of the handle and disposed at the end of the plunger shaft(115) which is opposing the main block form, with an inner spring also inserted into the cylindrical opening and disposed in direct contact with the interior of the snow release push button(114). The plunger(116) has a cap retainer ring(131) having a raised cylindrical shape that is of the same embodiment as the plunger(116) that is disposed near the top end of the plunger, and will act to allow the cap button to push or urge the plunger in a downward direction when initiated by the user. By pushing or urging the cap button downward, the cap retaining ring will act to push the plunger and plunger plate(116) in a downward direction, thereby releasing the snow block(132) from the main block form housing body(111). The cap spring will act to urge or push the cap back into and upward ready to use position.

The snow release plunger and plunger plate(116) comprises a plunger which is generally “H” shaped along approximately ¾ of the length of the plunger with the remaining approximately ¼ of the length of the plunger being a “+” shape that terminates into a cylindrical portion at the end of the plunger that comprises the retaining ring(131). The plunger shaft(115) portion of the main block form body has a shape that interacts with the plunger to inhibit the rotational movement of the plunger and plunger plate(116). The plunger is fixably attached to a flat rectangular plunger plate having a width and length which is slightly smaller than the interior dimension of the bottom opening of the main block body, and comprising a multitude of generally “L” shaped snow release tabs(133) that are integrated with a snow release tab support wall that runs down the middle of the length of the plunger plate.

The snow release tab support wall(134) embodies a multitude of holes(135) arrayed in a row, and extends from the bottom surface of the plunger plate in a perpendicular manner as illustrated in the enclosed FIG. 6, a distance that is equal to the approximate travel distance capability of the plunger and plunger plate.

The multitude of “L” shaped snow release tabs(133) extend from each side of the tab support wall(134) in a perpendicular manner, a short distance, approximately ¼″, and having either a uniform or a varying length. The snow release tabs are intended, in the preferred embodiment to alternate sides along the length of the tab support wall(134) so as to stagger along the length of the tab support wall. The plunger is inserted through the hole in the top surface of the main block body interior where the end of the plunger which opposes the rectangular plunger plate is disposed into contact with the cap retaining ring(131).

The trowel device(117) is a separate planar rectangular piece having a handle and a width and length that is slightly smaller than the outside dimensions of the vertical side walls, and a thickness that is approximately 1/16″ to ¼″ of an inch. In one embodiment of the invention the trowel device can be inserted into and held in position by first and second trowel retaining corner grooves or “L” shaped retaining tabs, as shown in FIG. 2, disposed generally towards the distal edges near the bottom corners of one of the two vertical side surfaces, whereby either the trowel device or the main snow block form body may comprise one or a multitude of raised or recessed surface features such as protrusions or concavities that are employed to engage once the trowel is placed into the storage position on the side of the main snow block form body. The trowel is further held in a fixed storage position by a horizontal tab that protrudes from the center, uppermost edge of the trowel retaining side surface a distance of approximately ⅛″ to ¼″, in a manner which is perpendicular to the side surface, having a length of approximately 1½″, and is used to engage the side of the trowel once it is in the stored non-use position. Other methods, not referred to herein, of connecting or fastening the trowel device to the main block housing may be used which perform the same function.

It is to be understood that the wall thickness of the substantially planar, vertical first and second side walls, and vertical first and second end walls are to be uniform from the top of the side and end walls to a point on the side and end walls that is equal to the approximate position of the plunger plate in its most downwardly extended, or snow releasing position, and then will comprise a slight taper that causes the side and end walls to become narrower towards the bottom of the side and end walls that create the main block form housing opening. This feature will aide in the smooth and uniform release of the snow block from the interior surface of the main block form housing body.

The present invention in alternate embodiments may be offered in a variety of shapes other than rectangular including but not limited in use to, round, oval, egg shaped, star shaped, triangular, square, hexagonal, octagonal, and other shapes not referred to herein which are to be considered apparent and obvious to the disclosure contained herein.

It is intended that a user grip the handle portion of the device and push the main form body in a downward motion into the substance which is to be formed, such as snow or sand. The user can then either pack the snow into the form body with a continual pushing motion, or can utilize the trowel device to pack the snow into the form body. The user can then lift the device and the packed snow by the handle, and thereby transport or carry the device to a desired location where the user then places the block into position and initiates the release of the snow block by pushing on the snow release cap button at the top of the handle, and thereby pushing the plunger and plunger plate in a downward direction towards the snow block, thereby pushing the snow block downward a distance that is equal to the travel distance capability of the plunger and plunger plate, thereby releasing the surface tension between the snow block and the interior walls of the main form body. Once the block is removed from the main form body, the device is once again ready for use.

While the present invention can be offered in a variety of sizes, the preferred embodiment has a width of approximately 4″, and a length of approximately 9″, and a height of approximately 9″ overall, with a main from body height of approximately 4″, including a material thickness of between approximately 1/16″ to ¼″. Additionally, the device having a handle shaft of approximately 1 to 1½″ diameter and a snow release button having a slightly smaller diameter than the handle shaft. It is to be understood that the approximate dimensions used in the preferred embodiment are only one example of the proportion and size that the invention can be offered in, with other sizes not referred to herein being considered apparent and obvious to the disclosure contained herein.

The present invention, in the preferred embodiment, is intended to be made of materials including cast or molded lightweight suitable plastics, with metal, steel, or other suitable materials being used for the springs and hardware where required.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

Accordingly several advantages and objects of the present invention are:

A principal objective of the present invention is to provide a Snow Block Forming & Transportation Device & Method of Use Thereof that will overcome the deficiencies of the prior art devices.

An objective of the present invention is to provide a Snow Block Forming & Transportation Device & Method of Use Thereof that allows a user to pack and shape material, such as snow, into rectangular shaped blocks for the use of constructing or building snow structures

Another objective of the present invention is to provide a Snow Block Forming & Transportation Device & Method of Use Thereof that will allow a user a more functional way of forming and transporting material such as snow.

Another objective of the present invention is to provide a Snow Block Forming & Transportation Device & Method of Use Thereof that allows a user to create snow structures with a uniform type and size of snow block.

Another objective of the present invention is to provide a Snow Block Forming & Transportation Device & Method of Use Thereof which makes it easier for a user to create and then release uniform snow blocks.

Another objective of the present invention is to provide a Snow Block Forming & Transportation Device & Method of Use Thereof that is inexpensive and easy to manufacture.

Another objective of the present invention is to provide a Snow Block Forming & Transportation Device & Method of Use Thereof that is lightweight, portable and easy to use, thereby allowing children and adults alike to easily create uniform snow block shapes.

Another objective of the present invention is to provide a Snow Block Forming & Transportation Device & Method of Use Thereof which can be offered in a variety of sizes and shapes including, square, rectangular, round, triangular hexagonal etc.

Another objective of the present invention is to provide a Snow Block Forming & Transportation Device & Method of Use Thereof that utilizes a plunger and plunger plate to urge or push the snow block out of the block form housing.

Another objective of the present invention is to provide a Snow Block Forming & Transportation Device & Method of Use Thereof which can be made in a variety of colors, and made out of recyclable materials.

It is intended that any other advantages and objectives of the present invention that become apparent or obvious from the detailed description or illustrations contained herein are within the scope of the present invention.

### BRIEF DESCRIPTION OF THE DRAWINGS

The following drawings further describe by illustration the advantages and objectives of the present invention.

FIG. 1. is a section view of a Snow Block Forming & Transportation Device, illustrating the plunger and plunger plate in the raised position.

FIG. 2. is a perspective view of a Snow Block Forming & Transportation Device according to the present invention, illustrating the plunger and plunger plate in the lowered position pushing a block of snow from the device.

FIG. 3. is a detailed view of the release push button portion of a Snow Block Forming & Transportation Device according to the present invention, illustrating the plunger and plunger plate in the lowered position.

FIG. 4. is a perspective view of a Snow Block Forming & Transportation Device according to the present invention, illustrating the trowel attached to the device.

FIG. 5. is a perspective view of a Snow Block Forming & Transportation Device according to the present invention, illustrating the trowel and snow release push button removed from the device.

FIG. 6. is a perspective exploded view of a Snow Block Forming & Transportation Device according to the present invention, illustrating the cap button, plunger and plunger plate removed from the device.

FIGS. 7 & 8. are side section views of a Snow Block Forming & Transportation Device according to the present invention, illustrating the various components of the invention including the plunger, plunger plate, cap button, integrated handle, spring well, retaining ring, and main block form housing body.

FIG. 9. is a perspective view of a plunger and plunger plate component of a Snow Block Forming & Transportation Device according to the present invention, illustrating the snow releasing aid fin wall and tabs at the underside of the plunger plate.

FIG. 10. is a perspective view of a snow release push button component of a Snow Block Forming & Transportation Device according to the present invention.

FIG. 11. is a perspective view of a snow shaping trowel component of a Snow Block Forming Device according to the present invention, illustrating the trowel removed from the main block body.

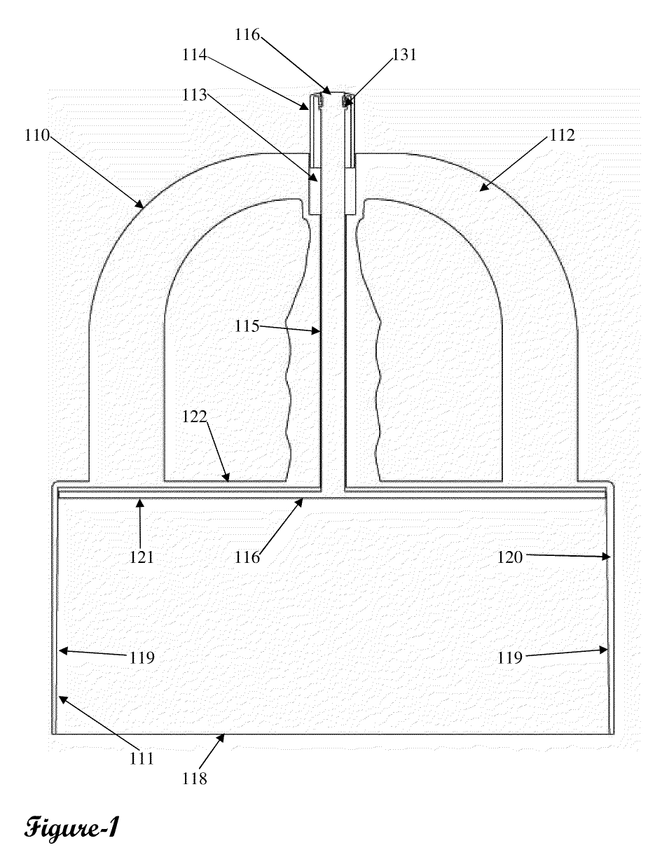

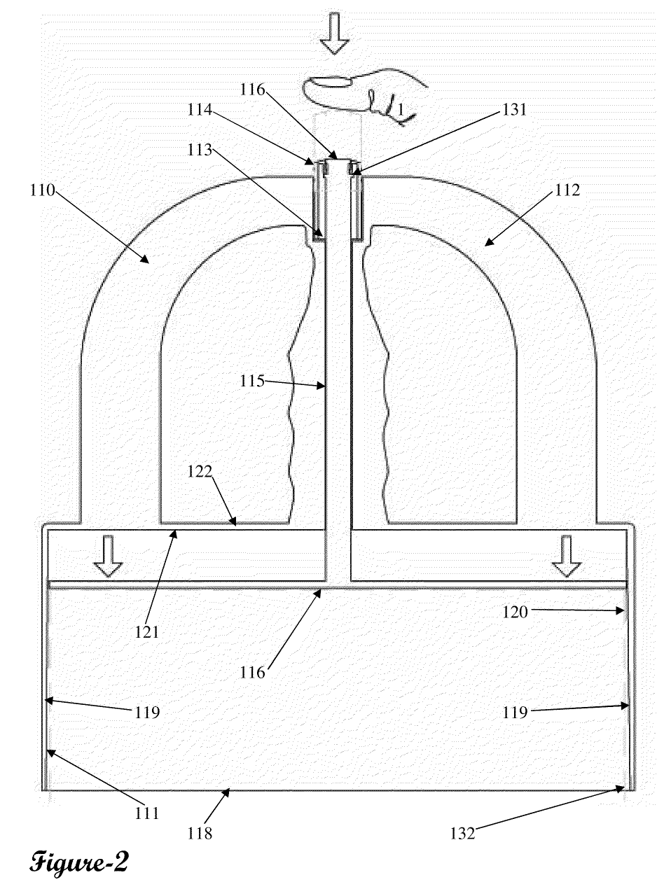

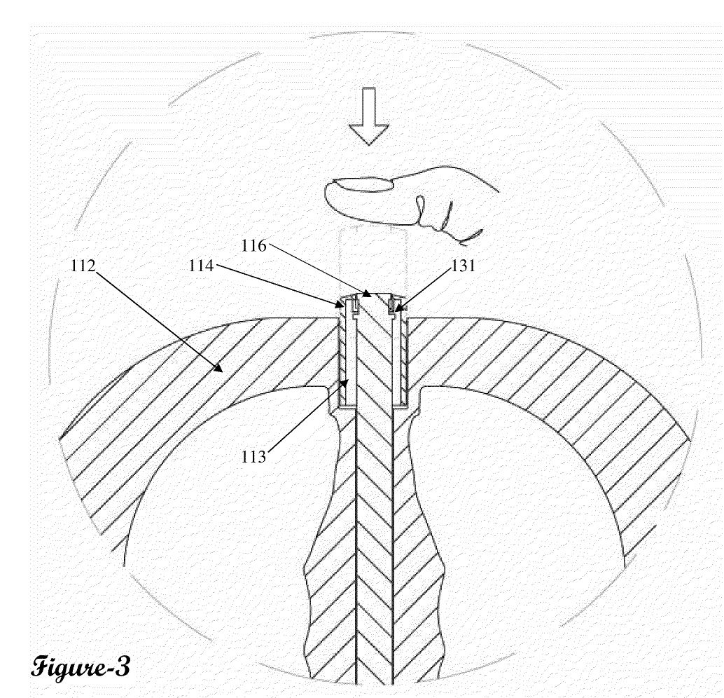

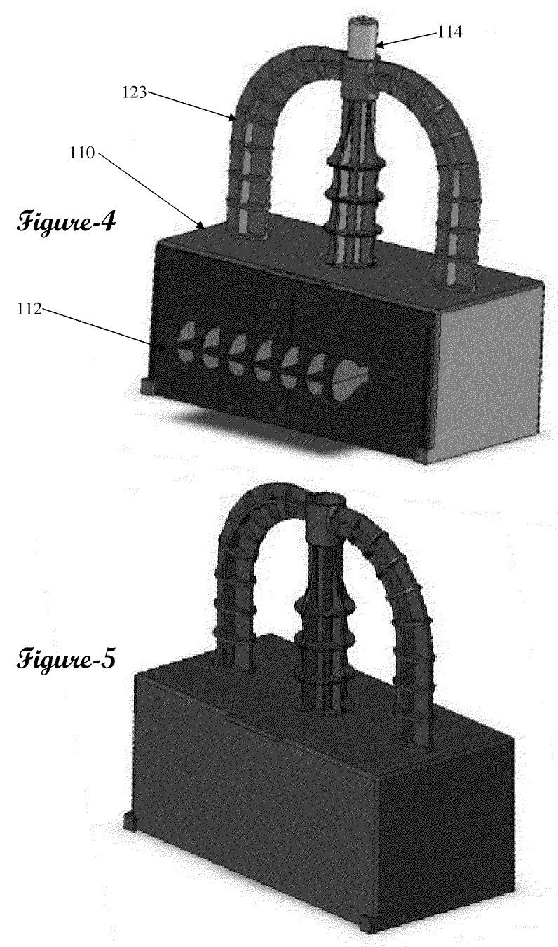

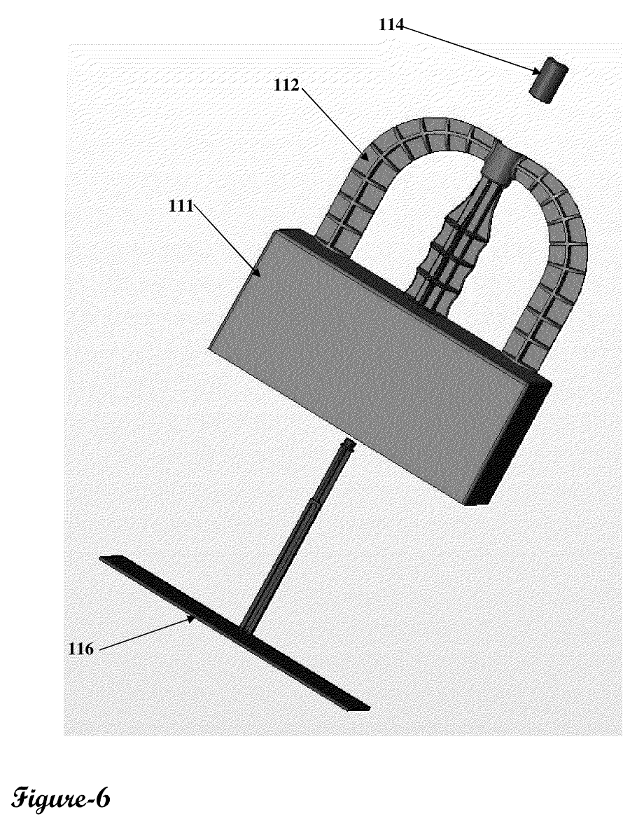

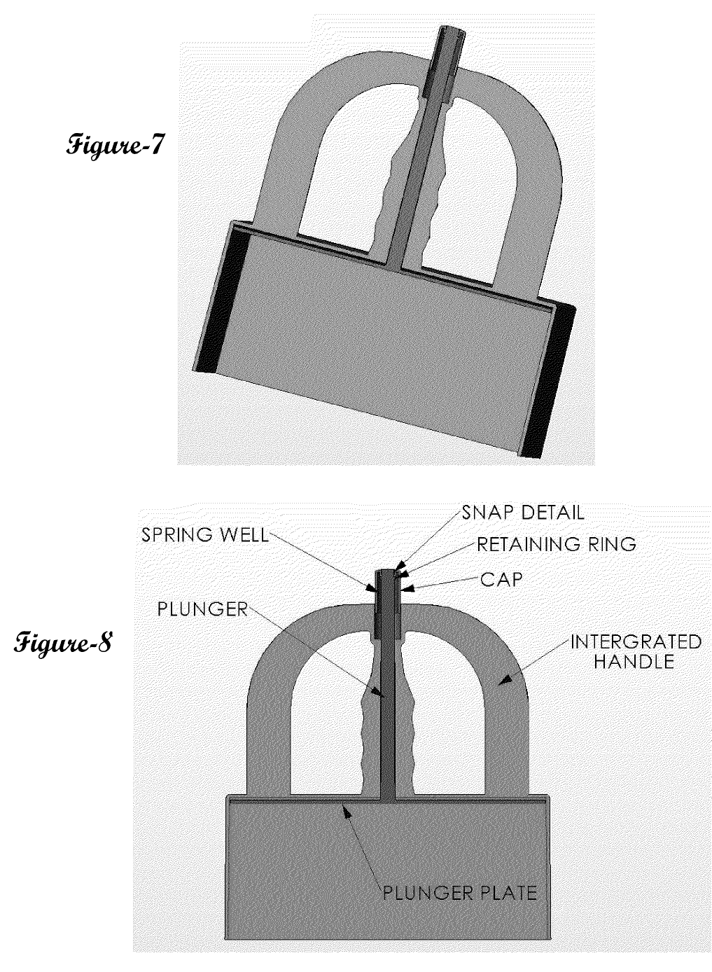

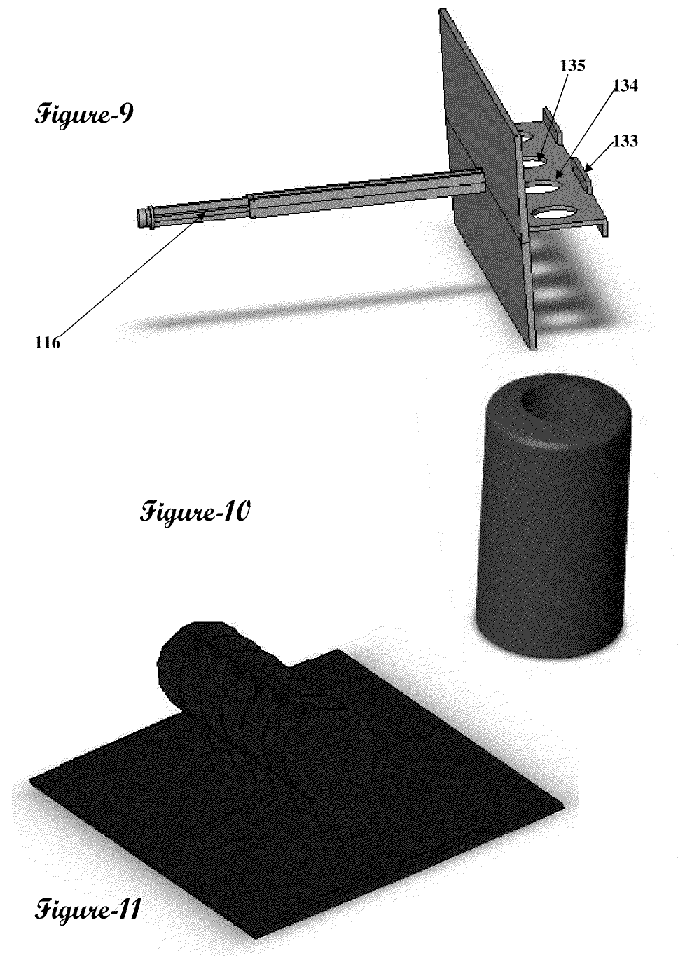

I Claim:

1. A snow block forming and transporting device and method of use thereof that generally comprises a main block form housing body, a main housing body integrated handle, an internal cap spring, a spring well, a snow release push button cap, a snow release plunger shaft, a plunger and plunger plate, and a snow shaping trowel.

2. The apparatus of claim 1 wherein the snow block housing is cylindrical in shape.

3. The apparatus of claim 1 wherein the snow block housing is triangular in shape.

4. The apparatus of claim 1 wherein the vertical side walls of the snow block housing are tapered.

5. A snow block forming and transporting device that will carry snow from one location to another in a secure manner until released by the user.

6. A snow block forming device that will release a formed block of snow by means of a plunger which is pushed by the user.
